(19) United States
(12) Patent Application Publication
(10) Pub. No.: US 2023/0134524 A1
(43) Pub. Date: May 4, 2023

(54) SYSTEMS TO MANAGE TELECOMMUNICATIONS CONNECTIONS

(71) Applicant: The Siemon Company, Watertown, CT (US)

(72) Inventor: Frank Velleca, Woodbury, CT (US)

(21) Appl. No.: 17/916,842

(22) PCT Filed: Jan. 21, 2021
(86) PCT No.: PCT/US2021/014309

§ 371 Date: Oct. 4, 2022

Related U.S. Application Data
(60) Provisional application No. 62/965,500, filed on Jan. 24, 2020.

(51) Int. Cl. G06F 3/16; H04M 3/22; G06F 21/31

(52) U.S. Cl. CPC G06F 3/167; H04M 3/229; G06F 21/31

(57) ABSTRACT

A voice command system for managing telecommunications connections among telecommunications equipment, the voice command system including: a voice assist unit including a speaker and a microphone; a network; a management system in communication with the voice assist unit over the network; the voice assist unit configured to receive verbal command from a user through the microphone; the management system configured to provide a response to the command.

### CROSS-REFERENCE TO RELATED APPLICATIONS

This application claims the benefit of U.S. provisional patent application No. 62/965,500 filed Jan. 24, 2020, the entire contents of which are incorporated herein by reference.

### BACKGROUND

Businesses and other organizations rely on their network infrastructure to run their daily operations. As the number of applications and the number of connections on the network increases, it becomes more difficult for customers to manage the network. The physical layer connections of the network need to be documented properly so the customer can make the best use of their network reduce network outages and increase security for their organization. There are existing products on the market that help customers manage the physical layer today. These systems are comprised of software that interfaces with scanner type devices that track and collect data on physical layer connections. Different methods are used to track physical layer connections. Some systems use a 9th wire in a patch cord and contacts either in outlets or on patch panels to track connections between patch panels or patch panels and switches. A small current is run through the contacts and the data on the connections is collected in a scanner device and relayed to the software. Other systems use a time-based logic to infer connections between patch panels. In this scenario, when one end of a patch cord is connected to a panel, the system looks for a second connection on another panel and assumes that that is the other end of the patch cord. Other systems use active jacks and use their MAC and IP addresses to track connection.

### SUMMARY

According to an embodiment, a voice command system for managing telecommunications connections among telecommunications equipment includes a voice assist unit including a speaker and a microphone; a network; a management system in communication with the voice assist unit over the network; the voice assist unit configured to receive verbal command from a user through the microphone; the management system configured to provide a response to the command.

According to another embodiment, a transponder system for managing telecommunications connections among telecommunications equipment includes an outlet including a transponder mounted in, on or near the outlet, the transponder including a transponder identifier; a transponder reader configured to read the transponder identifier; a network; a management system in communication with the transponder reader over the network; a plug including an antenna; the transponder reader configured to read the transponder identifier upon the antenna being near the transponder.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### DRAWING DESCRIPTION

FIG. 1 depicts a voice command system in an example embodiment.

FIG. 2 depicts a voice command system in an example embodiment.

FIGS. 3A and 3B depict a transponder system in an example embodiment.

FIGS. 4A and 4B depict detection of the mating and un-mating of a plug with an outlet in an example embodiment.

FIGS. 5A and 5B depict detection of the mating and un-mating of a plug with an outlet in an example embodiment.

FIG. 6 depicts physical contact between a transponder antenna and a plug antenna in an example embodiment.

### DETAILED DESCRIPTION

Embodiments of this disclosure relate to 1) a user interface system to aid in management and monitoring telecommunications connections and facilities assets/systems commonly found in enterprise and data center environments and 2) intelligent infrastructure management systems commonly used to manage, monitor and document telecommunications connections and facilities infrastructures. Example embodiments disclosed herein do not require specialized panels or cords. Example embodiments may retrofit standard panels and cords with sensor technology or may incorporate the sensing technology into panels or cords, if so desired.

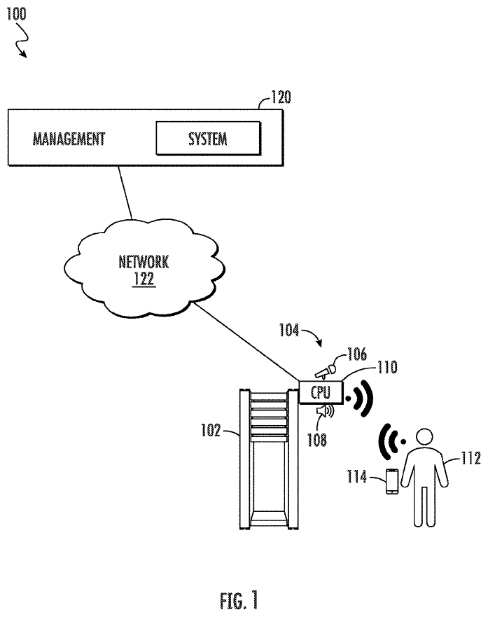

FIG. 1 depicts an example voice command system 100 in first example embodiment. Shown in FIG. 1 is telecommunications equipment including a telecommunications rack 102 which typically has a plurality of telecommunications connectors (e.g., outlets on patch panels) which mate with other telecommunications connectors (e.g., plugs on cables). Telecommunications connections may be arranged in a variety of structures, and a telecommunications rack 102 is one example. It is understood that a wide variety of telecommunications equipment may be used in the voice command system 100. A telecommunications rack 102 is one example of such telecommunications equipment.

A voice assist unit 104 includes a microphone 106, a speaker 108 and a controller 110 (e.g., a processor-based device having a processor, memory, etc.). The voice assist unit 104 may be mounted to the telecommunications rack 102 (or other physical structure). The voice assist unit 104 may also be worn by a user in the form of a headset. Commands from a user 112 may be transmitted by the voice assist unit 104 to a management system 120 over a network 122. The network 122 may be implemented using known wireless/wires networks such as WiFi (e.g., 802.11x), LAN, etc. The management system 120 may be implemented using known processor-based devices, such as a personal computer, server, or distributed computing platform (e.g., cloud computing). Responses from the management system 120 may be communicated to the user 112 by speaker 108.

The management system 120 maintains a database of the telecommunications connections. Voice recognition hardware and software (in the voice assist unit 104 and/or the management system 120), along with other elements, may be used to authenticate user access to areas, devices or other elements or actions associated with a telecommunications network or facilities infrastructure. For example, user 112 may state their name and the management system 120 verifies the user 112 is permitted access to the telecommunications connections. The user 112 may verbally enter patching connection and/or disconnection information for any type of device with any type of cord using any type of media. For example, user 112 may say “Connecting cord plug P704 to outlet O224.” The management system 120 stores the connection information and may provide a audible confirmation to speaker 108. The voice assist unit 104 may provide work order guidance or creation and user input. For example, for a work order, the management system 120 may provide audible step-by-step instructions to speaker 108, and receive verbal confirmations from microphone 106. The system may provide entry and/or retrieval of any data associated with assets or systems commonly found in telecommunications networks or facilities infrastructure. For example, the user 112 may say “What cable is connected to outlet O224?” The management system 120 would access the database and provide an audible response to the query through speaker 108. The system may provide for management of any other activities, such as responding to alarms/events. For example, if an alarm is present, the user 112 may say “Which patch panel is the alarm at?” The management system 120 would access the database and provide an audible response to the query through speaker 108.

A portable device 114 (e.g., a smartphone, tablet, watch, eyewear, etc.) may also be used to send verbal commands and receive audible instructions. The portable device 114 may also receive visual responses (e.g., messages, images, etc.) from the management system 120. The portable device 114 may be used in place of the voice assist unit 104, or in conjunction with the voice assist unit 104.

In voice command system 100 provides improved voice recognition for systems used in enterprise and data center environments. The voice command system 100 may use a limited lexicon of commands to improve the accuracy of the voice recognition by limiting possible input and response options. Responses and options are contextual, meaning that possible voice input or responses are limited based on the location, actions or other interactions between the user 112 and management system 120.

In operation, the user 112 primarily enters and retrieves data via voice commands Other methods/devices may be used in conjunction with voice recognition to enhance the system. 100. One example is use of a security camera to authenticate users. The management system 120 may respond with audible responses, messages on a rack mounted controller and/or message on the portable device 114. The voice assist unit 104 is depicted on a rack/cabinet, but it may be a fixed device attached to a rack, cabinet, ceiling, floor, wall or any other item. In other embodiments, the portable device 114 serves as the voice assist unit 104. The microphone 106, speaker 108 and CPU 110 may be a single unit, and may be incorporated in another device or may be separate devices. In another embodiment, the user may use a headset to interact with the fixed CPU 110. In another embodiment there is no device mounted in, on or near the racks or in the room. The device is a virtual machine or software appliance.

The management system 120 may be programed to recognize users 112 via voice authentication and/or voice passcode. In other authentication embodiments, the management system 120 may authenticate users via facial recognition, device proximity or other methods. The system shall have the ability to assist the user 112 if the user has problems with voice commands. Assistance may be audible or visual via any device (fixed, rack mounted, portable, etc.). Voice recognition software may reside on CPU 110, management system 120, and/or at a different location or be cloud-based. Voice recognition software will be contextual to limit available possible voice command matches and improve recognition accuracy. For example, if the user is working in a single cabinet, voice commands will be limited to actions which can be done on devices within that cabinet. This improves accuracy of voice commands.

The voice command system 100 may employ one or more variations. The voice assist unit 104 may be mounted somewhere in the telecommunications room, data center or data center row. The user 112 may interact with the system via a headset. In another embodiment, the voice assist unit 104 may be a single device mounted at a fixed location in proximity to the area where technicians perform IT and facilities tasks. In alternate embodiments, the voice assist unit 104 may be combined with a rack mounted control unit. In another embodiments, the microphone106, speaker 108 and CPU 110 may be separate units mounted at the same or different locations. In another embodiment, the microphone 106, speaker 108, and CPU 110 may be a portable device. Responses from the management system 120 may be audible, indications on a rack controller and/or to a mobile application. Responses may combine one or more of the methods described herein. Input to the management system 120 may be audible, indications on a rack controller and/or to a mobile application. Input may combine one or more of the methods described here. Processing of user input data and management system 120 responses may be done centrally in the management system 120 software, locally at the input/response device(s), at an intermediary application or any combination thereof. Another option is processing of data via a cloud-based application. One example of a cloud-based application is Google Voice. While the typical use of the voice command system 100 will be in a data center or telecommunications room, it should be noted that use of the voice command system 100 is not limited to the locations and may extend to any area where technicians or other staff need to interact with the management software or local system. Another use of the voice command system 100 is for access control and enhanced security. One use of the voice command system 100 would be for cabinet security access or monitoring. The voice command system 100 may authenticate a user 112 via voice recognition and grant access to a cabinet by unlocking the door. In another example the cabinet may not have a lock. A proximity sensor may detect when a user 112 is at or entering a rack and prompt them to enter a voice passcode, voice sample or other input for authentication. If authentication fails, the management system 120 may take additional steps to document or enforce access rules. Examples may include having a camera take a picture and store/send or trigger an alarm. Authentication may also apply to other tasks associated with telecommunications and facilities management. Authentication may be linked to user roles or approved actions.

The management system 120 may also employ enforcement methods to ensure users do not perform functions without entering data via one of the methods previously mentioned. For example, the management system 120 may detect when a user 112 is performing tasks within a rack or cabinet. This may be accomplished via a proximity sensor or other device. The management system 120 will prompt the user 112 for a response to authenticate the user 112 and gather information about the user actions being taken. If the user 112 does not respond to the system additional steps may be taken to detect the user 112, store the user, location and time of the infraction and send alarms.

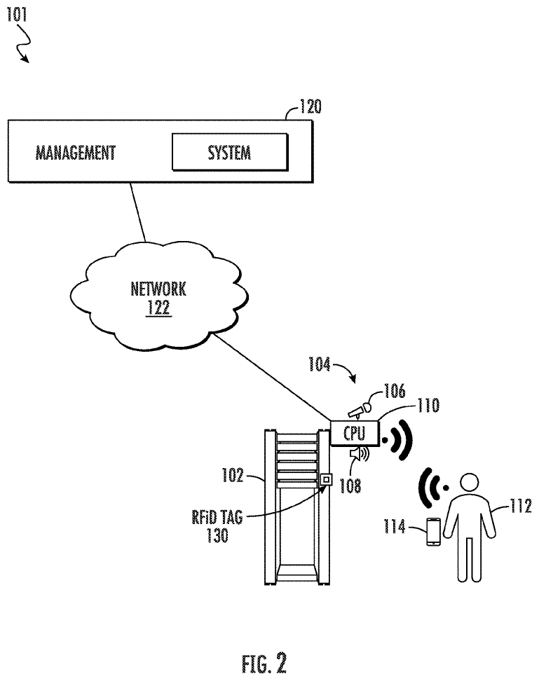

FIG. 2 depicts an example voice command system 101 in second example embodiment. The voice command system 101 is similar to voice common system 100, with the inclusion of one or more transponders 130. This voice command system 101 utilizes transponders 130, such as RFiD tags, to be affixed, attached, embedded or otherwise placed in, on or near items in a telecommunications and/or facilities infrastructure. The transponders 130 may be read by the user via a portable device 114. Once a transponder 130 is read, the transponder identifier is sent to the management system 120. Based on the transponder identifier, the management system 120 recognizes the location, device and/or telecommunications connector associated with the transponder 130. For example, the management system 120 may determine the transponder corresponds to rack 7, panel 4, outlet 12. The allows the management system 120 to provide more precise user interaction with the management system 120. Reading the transponder can be used as a shortcut for the management system 120 to know the location and device the user 1112 wants to interact with. For example, if the user reads a transponder 130 and then enters a voice command of “Connect port 5” the management system 120 will know the user is connecting an end of a cord into port 5 of the scanned device. Interaction between the user 112 and the management system 120 may be via voice (through voice assist unit 104), rack mounted display devices, portable device 114, or any combination thereof. The portable device 114 may interact with management system 120 directly via a microphone/speaker or any other input/response element. One example of another input/response element would be a mobile application executing on the portable device 114.

In one embodiment passive transponders are placed in, on or near devices and these transponders are associated with items in the management software database (or auxiliary database or data store). The user scans the transponders with a portable device and then interacts with the system via to input data and receive commands associated with the scanned device. In the preferred embodiment the user interacts with the system for data input and response via voice after the transponder scan. In other embodiments input and response interaction may be via voice, data input via fixed or portable device and any combination thereof.

The voice command system 100 may employ one or more variations. In example embodiments, the transponder 130 may be read with a fixed reader or fixed reader with a tethered attachment. The transponder 130 may be either passive or active and operate at any frequency range. In one embodiment transponder 130 only contains a unique ID numbers. In other embodiments, the transponder 130 may contain additional information about the devices, such as part number, description, etc. In alternate embodiments, the transponder 130 and transponder readers may be existing transponder tags and readers in the customer infrastructure. One example would be an existing transponder reader and card used for cabinet access. When the user opens the cabinet with their transponder access card the existing cabinet security system could exchange data with the management software and trigger a voice prompt for the user to initiate interaction with the system and input on actions for that cabinet or devices/ports within the cabinet. In another example the transponder reader may be for a room or location access and the transponder may be an access card. In other embodiments a mobile device, such as a smart watch of a mobile phone may act as the transponder card. In another embodiment there are no transponders placed on items. Each item has a reader and or/antenna and the user places an transponder within range of the reader/antenna. The transponder may be a card, smart watch, mobile device or any other transponder type or form factor. The reader/antenna may be separate units. The system determines the location, device and/or port via the reader/antenna through which the transponder was read. Another option is that the system writes data and/or instructions to the transponders. This information may be read via a portable device and be used for user guidance, instructions or other functions

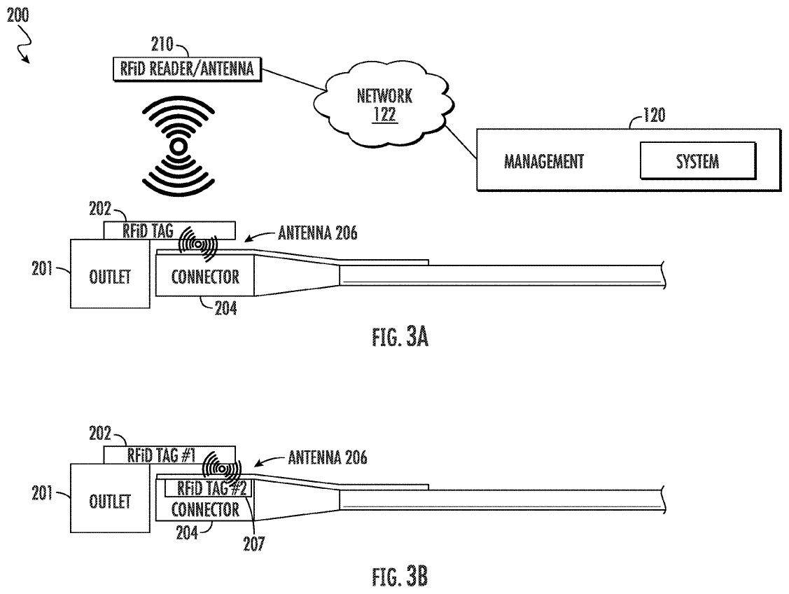

FIGS. 3A and 3B depict embodiments of a transponder system 200 that include transponders on components of the telecommunications components. As shown in FIG. 3A, a telecommunications connector 201 (e.g., an outlet) has a transponder 202 (e.g., an RFID tag) mounted in, on or near the outlet 201. The term outlet is used herein to refer to any telecommunication connector 201 that mates with another telecommunications connector, and includes outlets, adapters, couplers, ports, etc. employing copper, fiber, coax, and other connector topologies. A second telecommunication connecter 204 (e.g., a plug on a cable) includes an antenna element 206, which may extend along the cord connected to the plug 204. The term plug is used herein to refer to any telecommunication connector 204 that mates with another telecommunications connector, and includes plugs such as RJ-45, LC, twist-on, coax, etc. employing copper, fiber, coax, and other connector topologies. A transponder reader 210 (e.g., and RFID tag reader) is located at a distance from the outlet 201 such that the transponder reader 210 cannot read the transponder 202 until the plug 204, is mated with the outlet 201. It is understood that multiple transponder readers 210 may be employed in various locations. The antenna element 206 on plug 204 increases the read range of the transponder 202. In FIG. 3A, the transponder 202 is in, on or near the outlet 201 and electromagnetically couples, or physically contacts, with an antenna 206 when the plug 204 and outlet 201 are mated. When the plug 204 and outlet 201 are mated, the coupling of the antenna 206 with the transponder 202 allows the transponder reader 210 to read the transponder identifier. This information is provided to the management system 120. The management system 120 updates network data to indicate that a plug has been plugged into the outlet 201 associated with the transponder 202.

The transponder system 200 may be used in conjunction with the voice command systems 100 and 101. The transponder system 200 may be used as a standalone configuration. These transponders 202 are associated with the virtual outlets in the management system 120 database. One option to create the link of the virtual outlets with the transponders 202 in, on or near outlets is to store the transponder identifiers of each outlet with each virtual outlet in the management system 120. This is just one method to achieve the correlation between physical and virtual outlets. Others may be employed.

The transponder readers/210 are mounted in positions which allow them to read transponders 202 which are affixed in, on or near outlets 201 adapters when mated with plug 204 having antenna 206. Conversely, the transponder reader 210 will detect when the plug 204 has been un-mated from the outlet 201, as the transponder 202 identifier will no longer be detected. When the plug 204 is mated with the outlet 201, the transponder 202 electromagnetically couples to, or physically contacts with, the antenna 206 thereby increasing the read range of the transponder 202 and allows the transponder 202 to be read by the transponder reader 210. In another embodiment, an antenna on the transponder 202 makes physical contact with the antenna 206 on the plug 204. When a new transponder 202 is read by the transponder reader 210, the management system 120 will assume a connection has been made to that outlet 201. When a transponder 202 cannot be read, the management system 120 will recognize it as a disconnection. The management system 120 may look for two connections in a row and assume a patch connection has been made between two outlets 201 using a single patch cord having plugs 204 and antennas 206 at each end.

FIG. 3B depicts another embodiment in which an additional transponder 207 is placed in/on connectors 204 at each end of the patch cord. When the management system 120 reads a new outlet transponder 202 and a new plug transponder 207, the management system 120 recognizes this as a new connection. The management system 120 shall record the transponder identifiers corresponding to the plug 204 and outlet 201 of the mated connection. When the plug 204 and the outlet 201 are de-mated, the transponders 202 and 207 can no longer be read. The management system 120 shall recognize this as a disconnection and remove the mated information from the management system 120 database. If the transponder 207 from the previously mentioned de-mating is still read and another transponder 202 is read, the management system 120 shall record this as a new connection.

Other methods may be employed to improve functionality of the system 200. For example, there may be situations where all the outlets 201 of a panel are on/in a sliding tray. When the tray is slid in, all the transponders 202 within the panel/enclosure may not be read due to metal blocking on interfering with wireless communication to the transponder reader 210. The system may employ software algorithms to recognize multiple non-read transponder situations as a closed tray versus all outlet/adapter ports being disconnected at the same time. Note that processing of transponder read information may be done by a separate application or may be done in management software in the management system 120.

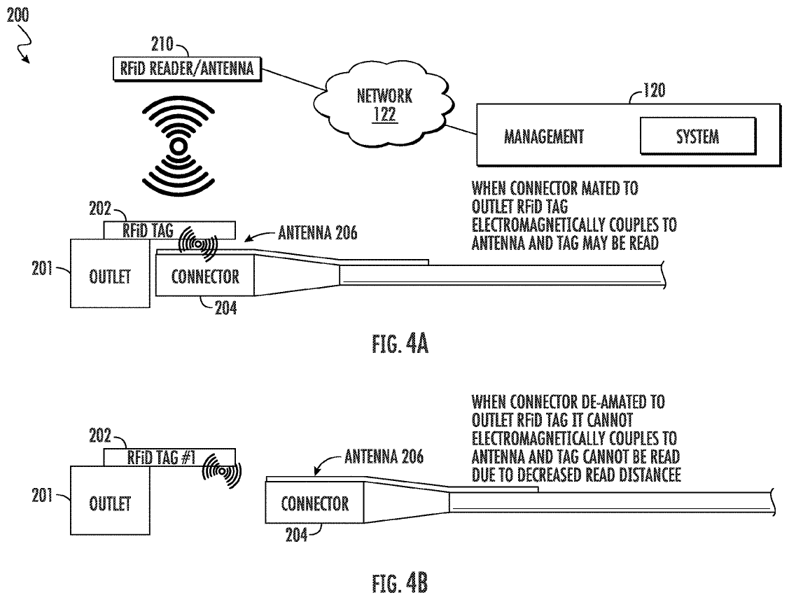

FIGS. 4A and 4B depict operation of the transponder system 200 when plug 204 is mated with outlet 201 (FIG. 4A) and un-mated from outlet 201 (FIG. 4B). FIG. 4A shows the embodiment with a single transponder 202 in, on or near the outlet 201 which couples/decouples from the antenna 206 in the cord of plug 204. As shown in FIG. 4A, when plug 204 is mated with outlet 201, the transponder 202 is electromagnetically coupled to the antenna 206 which allows the transponder reader 210 to read the transponder identifier from the transponder 202. As shown in FIG. 4AB when plug 204 is un-mated from outlet 201, the transponder 202 is no longer electromagnetically coupled to the antenna 206, which prevents the transponder reader 210 from reading the transponder identifier from the transponder 202.

The transponder 202 may be either passive or active. Embodiments do not limit the frequency range at which the transponders 201 may operate. Other embodiments may have two transponders 201 and 207. The two transponders 201 and 207 may operate at the same or different frequencies.

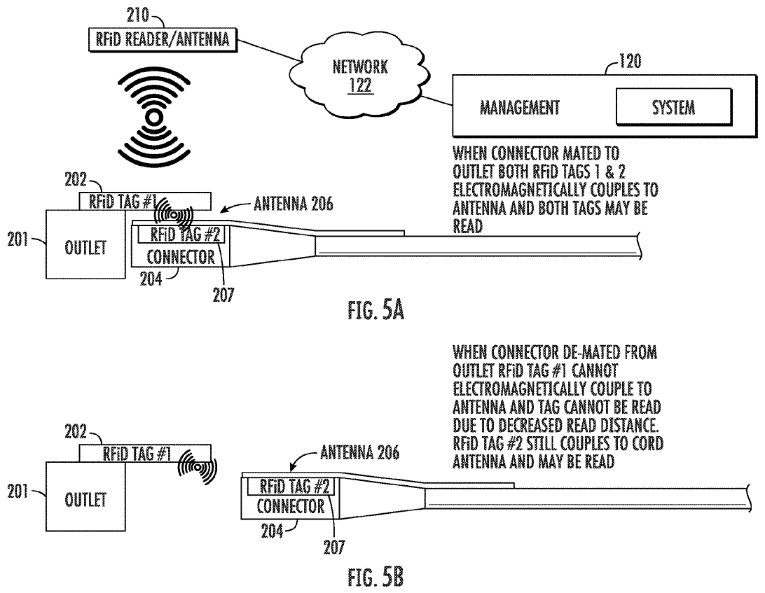

FIGS. 5A and 5B depict operation of the transponder system 200 when plug 204 is mated with outlet 201 (FIG. 5A) and un-mated from outlet 201 (FIG. 5B). FIGS. 5A-5B are similar to FIGS. 4A-4B, except in this embodiment the plug 204 includes a transponder 207. Transponder 207 is always coupled to the antenna 206 and can always be read by the transponder reader 210 as long as it is within read range of transponder reader 210. Reading of the transponder 202 on outlet 201 in FIGS. 5A-5B is similar to that described with reference to FIGS. 4A-4B.

In other embodiments, the plug antenna 206 is separated into two, electrically isolated sections. A user can complete the antenna circuit via a mechanical means (e.g., a piece of metal of other electrical conductor) and the transponders 202 and 207 associated with the outlet 201 and plug 204 are able to be read by the transponder reader 210. When the user releases the plug, the conductive path between the two antenna sections is broken and the outlet and plug transponders 202 and 207 are no longer readable by the transponder reader 210. This capability allows a single pair of transponders (or a single transponder) to be read at a time, reducing time required to read transponders and detect patching changes.

The transponder command system 200 may employ one or more variations. One embodiment has a transponder 202 in, on or near an outlet 201 and an antenna 206 in/on the connector/cord. The transponder 202 electromagnetically couples to, or physically contacts with, the antenna 206 to increase the read range of the transponder 202. In another embodiment, the transponder 202 in, on or near the outlet/adapter makes physical contact with the antenna 206 in the connector/cord. In another embodiment, there is an additional transponder 202 in/on the plug 204. The management system 120 tracks the unique identifiers of the mated pair of transponders 202 and 207. This information is used to determine connections and disconnections when a de-mating of the plug-outlet occurs. The transponder 207 on the plug 206 or cord may couple to the antenna 206 electromagnetically or via a physical connection. The antenna 206 may be any conductive material such as a copper conductor, conductive ink, or any other conductive material. The conductive material may be added to the connector/cord or may already be present in the structure of the connector/cord. In an embodiment, the transponders are passive and operate in the UHF range. Note that other embodiments may use different frequency ranges. Other embodiments may use active transponders and may operate at any frequency range. In another embodiment, the connector 204 or cord has a means to prevent the outlet transponder 202 from transmitting to the transponder reader 210. The plug 204 may use grounding of an outlet antenna or other signal blocking techniques. The system would use a non-response or response from the transponder 202 to determine a connection/disconnection. In another embodiment, the transponder 202 in, on or near the outlet 201 may be incorporated into a door. When the door is closed, the transponder 202 may not be read and the system assumes no connection. When the door is opened, the transponder 202 may be read and the management system 120 uses this to determine a connection has been made. The ability to read or not read a transponder may be based on either 1) the transponder position in relation to the reader/antenna which enables or prevents transponder reading 2) the transponder is deactivated based on a switch mechanism which enables or disables the transponder. The switch mechanism is triggered via the door opening/closing.

In another embodiment, a single outlet transponder 202 has a means to detect one or more plug 204 connection or disconnection status. For example, some fiber outlet/adapters may accommodate up to 4 discrete plugs. It may be difficult to place 4 individual transponders 202 in, on or near the outlet 201. To overcome this issue a single transponder may be placed in, on or near the outlet 201. This transponder may incorporate individual sensors which detect the presence or absence of a plug 204. The means for the transponder 202 to detect the individual plug 204 status may be mechanical, electrical, electromagnetic, optical or other. The connection/disconnection information is stored in the transponder 202 memory and can be read via the transponder reader 210, described previously.

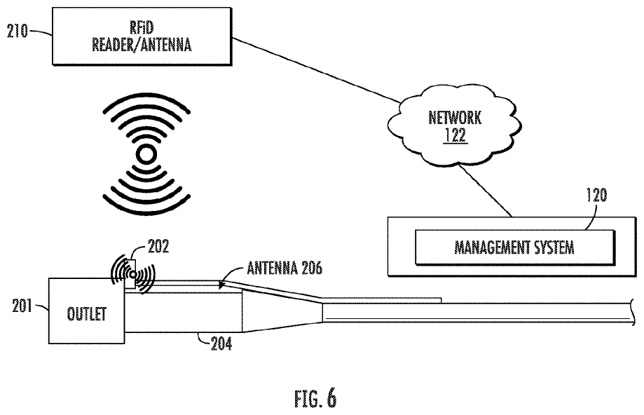

FIG. 6 depicts an embodiment where the antenna 206 on the cord of plug 204 makes physical contact with an antenna of the transponder 202 in, on or near the outlet 201. When the transponder 202 antenna and the plug antenna 206 make physical contact, this increases the read range of the transponder 202, allowing the transponder 202 to be read by the transponder reader 210.

Embodiments disclosed herein refer to management software operating on the management system 120. Such software is executed by a processor-based device such as a personal computer, server or distributed computing environment (e.g., cloud computing) having standard input/outputs, displays, etc. The management software maintains a database of network connections so that a map of port to port connectivity is available. The management software may be implemented using the Maplt automated infrastructure management software available from The Siemon Company. It is understood that other mated infrastructure management software may be used.

Embodiments of the invention provide infrastructure management, monitoring and documentation solutions which (i) works with virtually any type of device, media and port; (ii) reduces cost;. (iii) improves solutions for tracking connections on network equipment; (iv) works with standard cabling products providing more product options and use at existing installations; (v) offers a scalable system where customers can start with a basic system and add additional capabilities as their budget allows or needs increase; (vi) works with emerging smaller connector types and higher density applications; (vii) uses voice recognition systems to provide an easy method to access and input data used to manage, monitor and use systems and devices associated with enterprise/datacenter telecommunications and facilities networks.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A voice command system for managing telecommunications connections among
telecommunications equipment, the voice command system comprising:
a voice assist unit including a speaker and a microphone;
a network;
a management system in communication with the voice assist unit over the network;
the voice assist unit configured to receive verbal command from a user through the microphone;
the management system configured to provide a response to the command.

2. The voice command system for managing telecommunications connections of claim 1,
wherein the management system maintains a database of the telecommunications connections and updates the database in response to the verbal commands.

3. The voice command system for managing telecommunications connections of claim 1,
wherein the management system authenticates the user in response to the verbal command.

4. The voice command system for managing telecommunications connections of claim 3,
wherein the management system authenticates the user in response to voice authentication
or a voice passcode.

5. The voice command system for managing telecommunications connections of claim 1,
wherein the response to the command includes an audible response generated by the speaker.

6. The voice command system for managing telecommunications connections of claim 1,
wherein the voice assist unit is mounted to the telecommunications equipment.

7. The voice command system for managing telecommunications connections of claim 1,
wherein the voice assist unit includes a portable device.

8. The voice command system for managing telecommunications connections of claim 1,
further comprising a transponder mounted to the telecommunications equipment, the transponder including a transponder identifier.

9. The voice command system for managing telecommunications connections of claim 8,
wherein the management system is configured to provide the response to the command in
response to the transponder identifier.

10.-17. (canceled)
